(19) United States
(12) Patent Application Publication
(10) Pub. No.: US 2016/0350824 A1
(43) Pub. Date: Dec. 1, 2016

(54) System and Method for Establishing a Personalized Marketplace Accessible through Mobile Networks

(71) Applicant: Swyper LLC, Jackson, MS (US)

(72) Inventor: Thurman Knight Jones, Jackson, MS (US)

(73) Assignee: Swyper LLC, Jackson, MS (US)

(21) Appl. No.: 15/166,721

(22) Filed: May 27, 2016

Related U.S. Application Data
(60) Provisional application No. 62/167,617, filed on May 28, 2015.

(51) Int. Cl. G06Q 30/06; G06F 17/30; G06Q 20/32; G06Q 30/02; G06Q 50/00

(52) U.S. Cl. CPC G06Q 30/0613; G06Q 30/0629; G06Q 30/0269; G06Q 50/01; G06Q 20/32; G06F 17/30864; G06Q 30/0641

(57) ABSTRACT

The present disclosure provides system and method for establishing a personalized marketplace accessible through mobile networks comprising creating a user profile; downloading profile data regarding pre-designated social groups; storing data on a personal mobile device; interfacing with social media networks; interfacing with personal financial institution systems; utilizing targeted advertisement data; interfacing with a plurality of online retail systems; searching the plurality of online retail systems for product data; comparing product data from the plurality of online retail systems; compiling the comparison data into a user report; and displaying the compiled user report data on the personal mobile device.

### CROSS-REFERENCE TO RELATED APPLICATIONS

This application claims the benefit of, and priority to, pending U.S. Provisional Application No. 62/167,617 filed May 28, 2015, titled “System and Method for Establishing a Personalized Marketplace Accessible Through Mobile Networks.”

### FIELD OF INVENTION

The invention relates generally to a system and method useful while comparison shopping online with various retailers.

### BACKGROUND ART

Countless online retailers currently exist, allowing users to shop through the internet rather than in physical stores. In addition, many of these retailers have developed mobile applications which allow shoppers to utilize their smartphones or other mobile devices instead of traditional desktop computer interfaces. However, the vast majority of these mobile applications are retailer-specific and do not provide any capability for comparison shopping. Also, bulk online retailers such as Amazon sell a wide variety of products, but the sheer number of products offered result in a non-personalized shopping experience. Therefore, a need exists for a system and method that compiles product offerings from varied retailers and allows for more personalized experiences.

### SUMMARY OF INVENTION

In view of the foregoing shortcomings inherent in the conventional type of methods and systems now present in the prior art, the present invention provides a system and method for establishing a personalized marketplace accessible through mobile networks, which integrates multiple aspects of online shopping, including networking, social media, online shopping, targeted advertising, and online payment processing.

In one embodiment, the system comprises a personal mobile device; an online network; social media data; targeted advertisement data; retailer product data; and user financial institution information access

In another embodiment, the method comprises creating a user profile; downloading profile data regarding pre-designated social groups; storing data on a personal mobile device; interfacing with social media networks; interfacing with personal financial institution systems; utilizing targeted advertisement data; interfacing with a plurality of online retail systems; searching the plurality of online retail systems for product data; comparing product data from the plurality of online retail systems; compiling the comparison data into a user report; and displaying the compiled user report data on the personal mobile device.

Other objects and advantages of the present invention will become obvious to the reader and it is intended that these objects and advantages are within the scope of the present invention.

To the accomplishment of the above and related objects, this invention may be embodied in the form illustrated in the accompanying drawings, recognizing, however, that the drawings are illustrative only, and that changes may be made in the specific construction illustrated and described within the scope of the appended claims.

### BRIEF DESCRIPTION OF DRAWINGS

It should be noted that identical features in different drawings are shown with the same reference numeral.

FIG. 1 shows a diagram of one embodiment of the present invention.

### DETAILED DESCRIPTION

A system and method for establishing a personalized marketplace accessible through mobile networks has been developed. The present invention takes networking, social media, online shopping, targeted advertising, and online payment processing and integrates these features into a single system. The system allows users to easily browse, save, review, and purchase products both for themselves and for friends and family. A key feature of the present invention is the incorporation of social media into the mobile shopping experience.

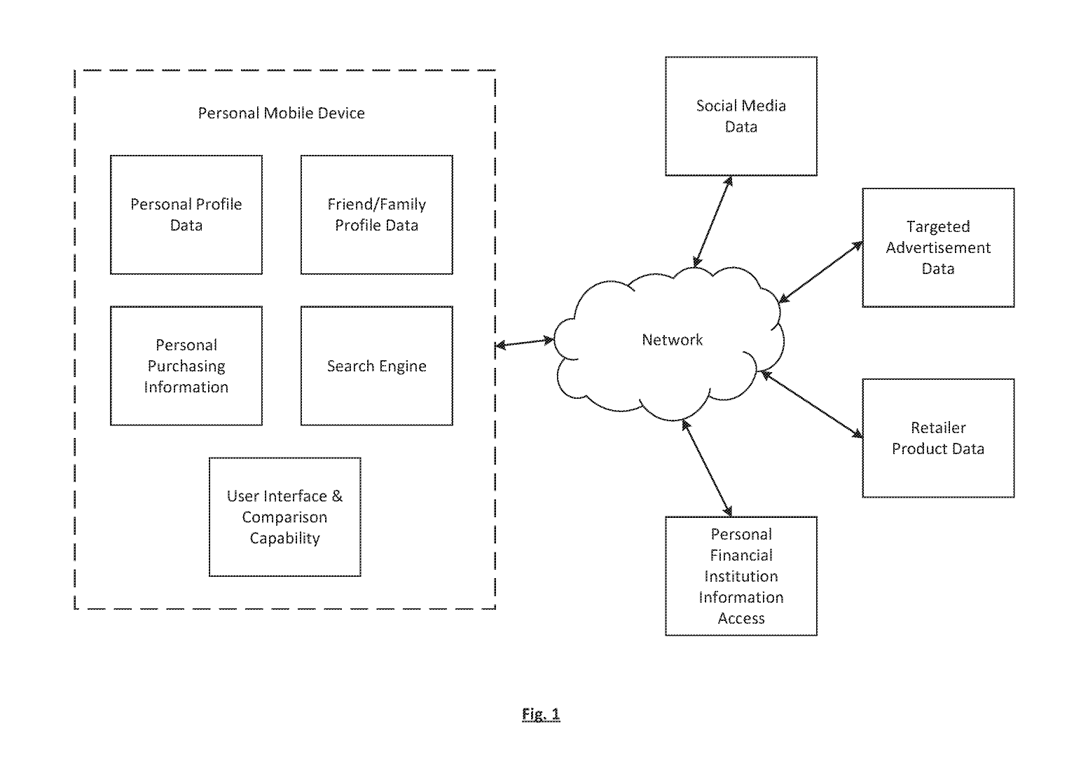

An example of the system and method for establishing a personalized marketplace accessible through mobile networks as depicted in FIG. 1 is as follows: a user creates a “personal profile” on his or her own personal mobile device. This personal profile can include information such as age, gender, clothing sizes, brand preference, style preference, interests, wish lists, shipping addresses, and other demographic information. The user may also create events for “friends and family,” or in the alternative, friend and family data can be downloaded from online social media platforms or from other user's systems. In one embodiment the events are based upon certain dates such as a child's birthday, anniversary or the like. In addition, the user includes “personal purchasing information” such as credit or debit card numbers so that items may be purchased directly. Data entered by a user regarding personal profiles, friend and family profiles, personal purchasing information, and the like may be stored directly on the personal mobile device. Alternatively, data may be stored in secure external databases.

The system includes a user interface on the personal mobile device, which may include direct “comparison capability.” Finally, the system includes a “search engine” located on the personal mobile device or in a network accessible to the personal mobile device. The search engine allows a user to manually enter certain product characteristics or information. Based on the entries, a variety of offered products will then be displayed for the user to compare and/or purchase. The user may also be able to save the searches and save the product listings themselves. The search engine may also function automatically based on personal profile data or friend and family profile data. For example, a user may be able to select a particular friend, and then the search engine may automatically generate product listings for review based on the friend's profile data or wish lists. In addition, a user may be able to browse through lists and select a particular product or category, and the search engine will then automatically produce listings for review. Browsing features may also contain filtering capabilities, such as price range or other product characteristics.

The user's personal mobile device has access to a “network” which connects it to various data sources. For example, the personal mobile device may be connected to a wireless network which allows it access to commonly used internet sources. Significantly, the present invention allows for the integration of “social media” to the system, and this social media component is a key differentiator to any current capability for mobile shopping. The social media data accessed by the system may include information for friends and family such as favorite colors, style or brand preferences, and personal interests. Data from social media sources greatly assists a user in gift-giving, and this data can be directly incorporated into the system. The system may allow a user to browse products that are specifically geared toward a particular friend or family member, and the user may purchase products directly through the system. In addition, users may be able to share product information and product purchases with those in their “contacts” list, making the experience social in nature.

Similarly, the network will be connected to a variety of product sources, including retailer websites. The “retailer data” will provide the system with information on product offerings, including price, availability, and popularity, as well as many other details. The ability of the system to connect to various retailer data provides a key feature of the present invention, which is the ability to compare product listings from different sellers.

The network will also provide the system access to the user's “personal financial institution,” in order to complete direct purchases. The user may have his or her personal purchasing information stored in the system, as discussed above, and therefore may be able to purchase products conveniently. However, in order to do so, the system network would need to provide secure access to the financial institution.

Another key feature of the system allows for “targeted advertisements” and directed sale information. Because a user enters personal profile information, the system may provide retailers access to user-specific information, thus providing a more targeted marketplace. The system may provide information such as purchase history, browsing or search history, personal wish lists, or personal profile information. This information allows retailers to see which products may be of interest to users, and which products are not. Product retailers using the system may be able to access inventories, allowing them to track, monitor, and control their product offerings and sales. These targeted advertisements and product offerings also allow the consumer to be exposed to a more effective marketplace. It will not be necessary for a consumer to wade through product offerings that are of no interest, but instead the user will be presented with products and information that are tailored specifically to his or her personal preferences. Of course, certain data may be protected automatically, such as personal purchasing information or any other information chosen by the user, and would not be submitted for any targeting.

In other embodiments of the present invention, the system will include a payment processing feature that will allow users to pay various parties for products purchased. Examples of payment methods may include PayPal®, the Automated Clearing House (ACH) system, direct credit card payments or any other suitable manner of electronic funds transfer. The system may also provide the capability to purchase, use, and give gift cards, whether retailer- or product-specific, or useful for any product purchased through the system. For certain retailers, gift cards purchased through the system may also be utilized at the retailer's physical store locations or online stores.

In some examples, the system is accessed through an online internet portal and maintained on a server. The system may be accessed through the internet over a computer, wireless device, mobile telephone or other suitable electronic device. In alternative embodiments, the system may be accessed through a dedicated application on a mobile device as discussed above, or a secondary interface such as Facebook or LinkedIn. Once accessed through such a device or application, a user will be able to utilize the full capabilities and features of the system. The present invention contemplates compatibility with a wide variety of platforms.

While the invention has been described with respect to a limited number of embodiments, those skilled in the art, having benefit of this disclosure, will appreciate that other embodiments can be devised which do not depart from the scope of the invention as disclosed here.

What is claimed is:

1. A system for establishing a personalized marketplace accessible through mobile networks, comprising:
a. a personal mobile device;
b. an online network connected to the personal mobile device;
c. social media data stored on the online network;
d. targeted advertisement data stored on the online network;
e. retailer product data stored on the online network;
f. user financial institution information access; and
g. a payment processor.

2. The system of claim 1, wherein the personal mobile device further comprises user profile data.

3. The system of claim 1, wherein the personal mobile device further comprises user purchasing data.

4. The system of claim 1, wherein the personal mobile device further comprises pre-designated social group profile data.

5. The system of claim 1, wherein the personal mobile device further comprises a search engine.

6. The system of claim 1, wherein the personal mobile device further comprises a user interface.

7. The system of claim 1, wherein the personal mobile device further comprises a comparison analysis output report.

8. The system of claim 1, wherein the personal mobile device further comprises a network interface.

9. A method for establishing a personalized marketplace accessible through mobile networks, comprising:
a. creating a user profile on a personal mobile device;
b. downloading profile data regarding pre-designated social groups determined from the user profile;
c. storing data on a personal mobile device;
d. interfacing with online social media networks;
e. interfacing with online personal financial institution systems;
f. utilizing targeted advertisement data stored on an online network;
g. interfacing with a plurality of online retail systems;
h. searching the plurality of online retail systems for product data;
i. comparing product data from the plurality of online retail systems;
j. compiling the comparison data into a user report; and
k. displaying the compiled user report data on the personal mobile device.

10. The method of claim 9, wherein the user profile includes personal purchasing information.

11. The method of claim 10, further comprising creating one or more events based on the downloaded data regarding pre-designated social groups.

12. The method of claim 10, further comprising saving search data and product listings in a storage database.

13. The method of claim 10, further comprising purchasing a product from the compiled user report.

14. The method of claim 10, wherein the user manually enters search terms.

15. The method of claim 10, wherein the search terms are automatically generated based on the user profile and downloaded data.

16. The method of claim 10, further comprising sharing compiled user report data with outside networks.

17. The method of claim 10, further comprising saving purchase history in a storage database.

18. The method of claim 10, further comprising sharing purchase history with outside networks.

19. The method of claim 10, further comprising utilizing a server for storing data.
